(19) United States
(12) Patent Application Publication
(10) Pub. No.: US 2025/0175756 A1
(43) Pub. Date: May 29, 2025

(54) TECHNIQUES FOR ADDING DISTANCE-DEPENDENT REVERB TO AN AUDIO SIGNAL FOR A VIRTUAL SOUND SOURCE

(71) Applicant: HARMAN INTERNATIONAL INDUSTRIES, INCORPORATED, Stamford, CT (US)

(72) Inventors: Alfredo FERNANDEZ FRANCO, Los Angeles, CA (US); Anton MATUSHKIN, Budapest (HU)

(21) Appl. No.: 18/520,208

(22) Filed: Nov. 27, 2023

(51) Int. Cl. H04S 7/00

(52) U.S. Cl. CPC H04S 7/303; H04S 7/305

(57) ABSTRACT

Various embodiments disclose a computer-implemented method for producing a perceived location of a sound source in an acoustic environment. The method includes: determining a current position of a first virtual audio source relative to a listening area of the acoustic environment; based on the current position of the first virtual audio source, determining a wet-signal distribution; generating a first virtual audio signal for a first physical sound source that is included in the acoustic environment, wherein the first virtual audio signal is associated with the first virtual audio source and is based on the wet-signal distribution; and transmitting the first virtual audio signal to the first physical sound source for output by the first physical sound source.

### BACKGROUND

### Field of the Various Embodiments

The various embodiments relate generally to audio systems and, more specifically, to techniques for adding distance-dependent reverb to an audio signal for a virtual sound source.

### Description of the Related Art

Due to advances in real-time audio processing and distribution, augmented reality techniques can be implemented in an acoustic environment to produce sound localization of a virtual sound source. For example, differences in the timing and intensity of sound produced by different speakers in an acoustic environment can emulate the auditory cues relied on by the human auditory system to perceive location. Such augmented reality techniques enable a user to have a more realistic experience when encountering a virtual sound source in an acoustic environment.

One drawback of conventional augmented reality techniques is that they are limited in their ability to accurately simulate large distances accurately. For example, in a small acoustic environment, where the speakers for producing a virtual audio source are relatively close together, sound localization produced by differences in the timing and intensity of sound output by such speakers is unable to realistically simulate a large room or large distances for the human auditory system. As a result, conventional augmented reality techniques cannot emulate a virtual sound source that is located in a large acoustic space or at a relatively large distance, and the listener does not have an immersive experience.

In light of the above, more effective techniques for generating audio signals for a virtual sound source are needed.

### SUMMARY

Various embodiments disclose a computer-implemented method for producing a perceived location of a sound source in an acoustic environment. The method includes: determining a current position of a first virtual audio source relative to a listening area of the acoustic environment; based on the current position of the first virtual audio source, determining a wet-signal distribution; generating a first virtual audio signal for a first physical sound source that is included in the acoustic environment, wherein the first virtual audio signal is associated with the first virtual audio source and is based on the wet-signal distribution; and transmitting the first virtual audio signal to the first physical sound source for output by the first physical sound source.

Further embodiments provide, among other things, non-transitory computer-readable storage media storing instructions for implementing the method set forth above, as well as a device or a system configured to implement the method set forth above.

At least one technical advantage of the disclosed techniques relative to the prior art is that the disclosed techniques enhance the perception of distance associated with a virtual sound source and surrounding acoustic environment. A further advantage of the disclosed techniques is that more accurate spatial information is conveyed to the listener, thereby facilitating perception of the location of a virtual sound source. In some instances, a virtual sound source is perceived by a listener to be more distant than is actually the case, and in other instances, the virtual sound source is perceived by the listener to be in a larger acoustic environment than is actually the case. Taken together, the above advantages provide the listener with a more immersive experience in an acoustic environment. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of an audio system configured to implement one or more aspects of the present disclosure;

FIG. 2 is a conceptual illustration of an acoustic environment with a listening area disposed therein, according to various embodiments;

FIG. 3 is a graph illustrating a function for determining a wet-signal distribution 186, according to an embodiment;

FIG. 4 sets forth a flow diagram of method steps for emulating a distant virtual sound source in an acoustic environment, according to various embodiments of the present disclosure;

FIG. 5 is a conceptual illustration of an acoustic environment with a listening area disposed therein, according to various embodiments;

FIG. 6 is a graph illustrating a function for determining a wet-signal distribution 186, according to an embodiment; and

FIG. 7 sets forth a flow diagram of method steps for a distant virtual sound source in a large acoustic environment, according to various embodiments of the present disclosure.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

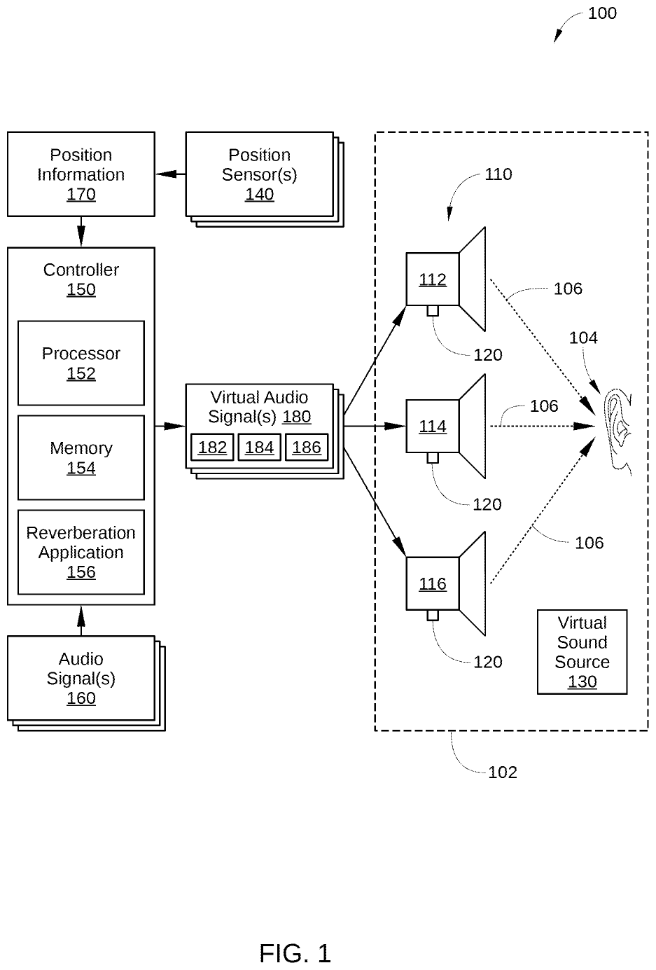

FIG. 1 illustrates a block diagram of an audio system 100 configured to implement one or more aspects of the present disclosure. According to the embodiments, audio system 100 enables a virtual sound source in an acoustic environment 102 to sound more realistic to a listener 104 or other user present in acoustic environment 102. Thus, sounds generated by physical sound sources 112, 114, and 116 (referred to collectively herein as physical sound sources 110) for the virtual sound source are perceived by listener 104 to more realistically and accurately emulate real-world sounds. Acoustic environment 102 can be, without limitation, a space or room in which physical sound sources 110, a virtual sound source 130, and listener 104 are disposed. In the embodiment illustrated in FIG. 1, audio system 100 includes, without limitation, multiple physical sound sources 110, a controller 150, a virtual sound source 130, and, in some embodiments, one or more position sensors 140. Controller 150 includes, without limitation a processor 152, memory 154, and a reverberation application 156.

Physical sound sources 110 are audio output devices that generate sound outputs 106 within acoustic environment 102, such as sound outputs associated with virtual sound source 130. For example, physical sound sources 110 can include devices capable of providing a sound output, such as a loudspeaker. Physical sound sources 110 can be a wired or wireless speaker system (e.g., one or more loudspeakers, amplifiers, etc.), or any other device that generates sound output 106. In some embodiments, each physical sound source 110 can include a position sensor 140 that indicates a position of that particular physical sound source 110 in acoustic environment 102, such as an inertial measurement unit (IMU), a wireless transmitter, or other electronic device.

Virtual sound source 130 can be any position-trackable object for which audio system 100 can produce a perceived spatial location within acoustic environment 102 for listener 104, for example via sound outputs 106. For example, in some embodiments, virtual sound source 130 can correspond to a toy or other electronically or visually tagged device that is configured so that position sensors 140 can generate position information indicating the current position of virtual sound source 130. In some embodiments, virtual sound source 130 includes an electronic device or tag that transmits to one or more position sensors 140 position information indicating the current position of virtual sound source 130 within acoustic environment 102. Alternatively or additionally, in some embodiments, virtual sound source 130 includes one or more visual tags or markers that enable optical sensors included in position sensors 140 to optically determine position information indicating the current position of virtual sound source 130 within acoustic environment 102. Thus, as virtual sound source 130 moves within and/or is repositioned within acoustic environment 102, audio system 100 can determine the current position of virtual sound source 130 via position sensors 140 and controller 150. Audio system 100 can then produce appropriate sound outputs 106 that cause listener 104 to perceive sound being emitted from the current position of virtual sound source 130.

Position sensors 140 can include, without limitation, an array of one or more different sensors configured to receive signals, perform measurements, or otherwise generate position information 170 indicating the current location of virtual sound source 130 within acoustic environment 102. In some embodiments, position sensors 140 can detect or measure one or more properties associated with virtual sound source 130 and/or acoustic environment 102. Position sensors 140 can include, without limitation, optical sensors (visible light or infrared), acoustic sensors (such as ultrasound sensors, active sonar, and the like), RADAR sensors, LIDAR sensors, depth sensors, stereoscopic imaging sensors, topography mapping sensors, telematic sensors, receivers, and so forth. In such embodiments, position sensors 140 are configured to receive sensor data and to transmit the sensor data as position information 170 to controller 150 for processing. Alternatively, in some embodiments, position sensors 140 receive position information 170 that is transmitted from virtual sound source 130, for example from an IMU or other electronic device included in virtual sound source 130.

Controller 150 generates one or more virtual audio signals 180 and drives physical sound sources 110 to generate sound outputs 106 that can produce a perceived location of virtual sound source 130 to listener 104. In the embodiment illustrated in FIG. 1, controller 150 includes a processor 152, a memory 154, and a reverberation application 156. Processor 152 is configured to read data from and write data to memory 154. In various embodiments, an interconnect bus (not shown) connects processor 152, memory 154, and any other components of processor 152.

Reverberation application 156 generates a reverberation signal, such as reverberant signal 184, based on a particular base audio signal 182. Reverberation application 156 can be any technically feasible software application for generating a reverberation signal from an input signal. Any suitable reverberation algorithm can be included in reverberation application 156.

Processor 152 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of different processing units, such as a CPU configured to operate in conjunction with a GPU. In general, processor 152 can be any technically feasible hardware unit capable of processing data and/or executing software applications. In some embodiments, reverberation application 156 and/or other instructions residing in memory 154 can be executed by processor 152 to implement the overall functionality of controller 150.

Memory 154 can include a random-access memory (RAM) module, a flash memory unit, an EEPROM, or any other type of memory unit or combination thereof. In various embodiments, memory 154 includes non-volatile memory, such as an optical drive, magnetic drive, flash drive, or other storage. In some embodiments, separate data stores, such as external data stores included in a network (“cloud storage”) can supplement or constitute memory 154.

In operation, controller 150 receives one or more audio signals 160 and position information 170. Based on position information 170, controller 150 modifies the one or more audio signals 160 to generate virtual audio signals 180 for physical sound sources 110. In some embodiments, controller 150 receives a different audio signal 160 for each physical sound source 110, and generates a different virtual audio signal 180 for each physical sound source 110. For example, in some embodiments, the audio signals 160 are varied for each physical sound source to produce sound localization of virtual sound source 130 within acoustic environment 102.

In some embodiments, each different audio signal 160 is associated with the same virtual sound source 130, but is tailored for a different physical sound source 110. For example in one such embodiment, a magnitude of each audio signal 160 is varied. In such an embodiment, the magnitude of each audio signal 160 is varied to accurately distribute audio from virtual sound source 130 to physical sound sources 110 in a way that is perceptually accurate in terms of timber and localization accuracy, thereby causing listener 104 to perceive the source of sound outputs 106 to coincide with the current location of virtual sound source 130. However, as noted previously, sound localization produced in this way is unable to realistically simulate a large room or large distances for the human auditory system. Consequently, according to various embodiments, controller 150 generates each virtual audio signal 180 by modifying the corresponding audio signal 160 as described below.

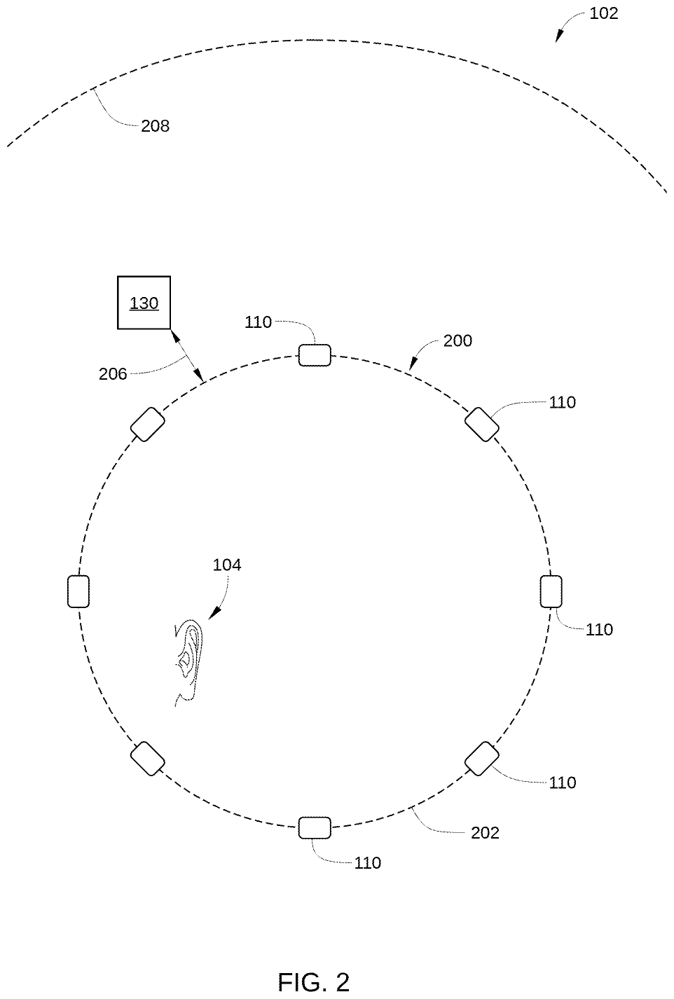

In some embodiments, controller 150 generates a particular virtual audio signal 180 (e.g., the virtual audio signal 180 for physical sound source 112) by producing a reverberant signal 184 that is based on a particular base audio signal 182 (e.g., the audio signal 160 for physical sound source 112). The base audio signal 182 and the corresponding reverberant signal 184 are then mixed according to a distance-dependent wet-signal distribution 186. In some embodiments, controller 150 determines the distance-dependent wet-signal distribution 186 based on a location of virtual sound source 130 in acoustic environment 102, and in other embodiments, controller 150 determines the distance-dependent wet-signal distribution 186 based on a size of a listening area within acoustic environment 102. Examples of such embodiments are described below in conjunction with FIGS. 2-7.

### Reverb for Emulation of Distant Virtual Sound Source

In some embodiments, controller 150 generates virtual audio signals 180 with a reverb signal component (e.g., as reverberant signal 184) to emulate a distant virtual sound source 130, such as when virtual sound source 130 is disposed outside of a listening area of acoustic environment 102. In such embodiments, controller 150 determines a distance-dependent wet-signal distribution 186 based on a location of virtual sound source 130 in acoustic environment 102 relative to the listening area. One embodiment of a listening area in acoustic environment 102 is described below in conjunction with FIG. 2.

FIG. 2 is a conceptual illustration of acoustic environment 102 with a listening area 200 disposed therein, according to various embodiments. Also shown in acoustic environment 102 are virtual sound source 130, listener 104, a boundary 202 (dashed lines) of listening area 200, and a maximum reverb boundary 208 (dashed lines). As virtual sound source 130 changes position within or proximate listening area 200, audio system 100 modifies the virtual audio signals provided to physical sound sources 110 to generate sound localization within listening area 200 that causes listener 104 to perceive sound outputs from physical sound sources 110 to coincide with the current location of virtual sound source 130. According to various embodiments, audio system 100 further generates these virtual audio signals with a reverb signal component (e.g., reverberant signal 184 in FIG. 1) that is mixed with a base audio signal (e.g., base audio signal 182) based on a distance-dependent wet-signal distribution (e.g., a distance-dependent wet-signal distribution 186).

As shown, listening area 200 includes a boundary 202 that indicates an extent of listening area 200. In some embodiments, controller 150 determines boundary 202 based on the positions of physical sound sources 110. For example, in the embodiment illustrated in FIG. 2, boundary 202 is implemented as a circle that encompasses (e.g., circumscribes) all physical sound sources 110 in acoustic environment 102. In some embodiments, the size and position of the circle is selected to be a circle with the smallest radius that encloses all of physical sources 110. In other embodiments, boundary 202 can be implemented as any other technically feasible shape, such as a polygon, in which each physical sound source 110 corresponds to a vertex of the polygon, or a geometric shape (e.g., a square, rectangle, triangle, hexagon, and the like) that encompasses all of physical sound sources 110.

According to various embodiments, when virtual sound source 130 is disposed within the confines of boundary 202 of listening area 200, a first reverberation approach is employed in the generation of a virtual audio signal 180. Conversely, when virtual sound source 130 is disposed outside the confines of boundary 202 of listening area 200, a second reverberation approach is employed in the generation of a virtual audio signal 180. In such embodiments, in the first reverberation approach, virtual audio signals 180 are generated with no reverb signal component, while in the second reverberation approach, virtual audio signals 180 are generated with a reverb signal component that is mixed with a base audio signal based on a distance-dependent wet-signal distribution. Thus, in such embodiments, when virtual sound source 130 is disposed outside boundary 202, a more realistic and natural listening experience is produced for listener 104 by generating virtual audio signals 180 for physical sound sources 110 that cause the position of virtual sound source 130 to be perceived by listener 104 as farther away.

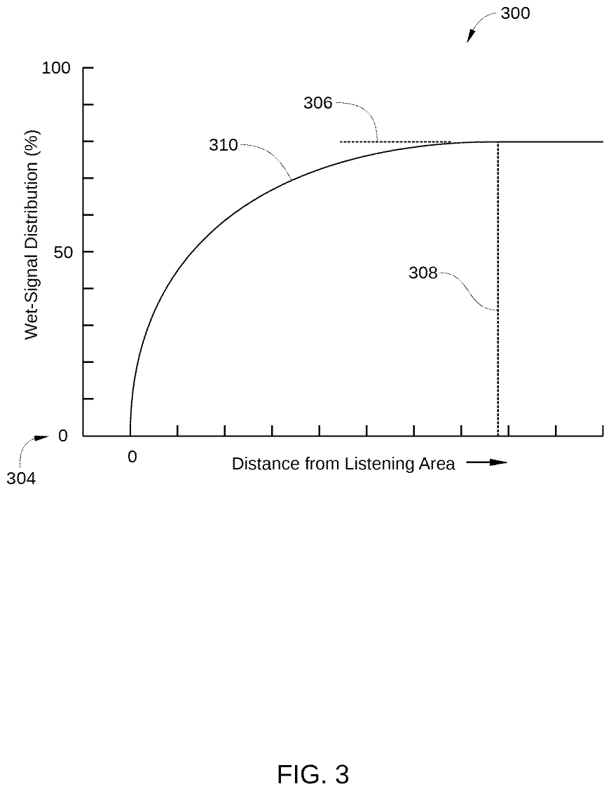

In some embodiments, when virtual sound source 130 is disposed outside boundary 202, controller 150 (for example via reverberation application 156) generates each virtual audio signal 180 based on a particular base audio signal 182, a reverberant signal 184, and a distance-dependent wet-signal distribution 186. In such embodiments, controller 150 determines a value for distance-dependent wet-signal distribution 186 based on a distance 206 between virtual sound source 130 and boundary 202. In some embodiments, controller 150 determines the value for distance-dependent wet-signal distribution 186 further based on whether virtual sound source 130 is disposed at or beyond maximum reverb boundary 208. Various embodiments of the determination of wet-signal distribution 186 are described below in conjunction with FIG. 3.

FIG. 3 is a graph 300 illustrating a function 310 for determining a value for wet-signal distribution 186, according to an embodiment. Function 310 enables selection of a value of wet-signal distribution 186 based on a distance of virtual sound source 130 from boundary 202 of listening area 200, such as distance 206 in FIG. 2. As shown, function 310 increases from a minimum wet-signal value 304 value of 0% (which corresponds to when virtual sound source 130 is disposed at or within boundary 202) to a maximum wet-signal value 306 (which corresponds to when virtual sound source 130 is disposed at a position that is greater than or equal to a maximum reverb distance 308). Thus, as virtual sound source 130 moves farther away from boundary 202, the value of wet-signal distribution 186 increases, causing virtual audio signals 180 to include a greater mix of reverberant signal 184 and cause a listener to perceive virtual sound source 130 to be located at a greater distance.

It is noted that, as the value of wet-signal distribution 186 (as indicated by function 310) increases, virtual audio signals 180 include a proportionally smaller mix of base audio signal 182. Therefore, function 310 indirectly indicates the mixture of dry signal for virtual audio signals 180. For example, when function 310 indicates a wet-signal distribution value of 0%, virtual audio signals 180 are mixed to include 100% base audio signal 182. Similarly, when function 310 indicates a wet-signal distribution value of 50%, virtual audio signals 180 are mixed to include 50% base audio signal 182.

In the embodiment illustrated in FIG. 3, function 310 varies non-linearly with distance from boundary 202 up to maximum wet-signal value 306. For example, in the embodiment illustrated in FIG. 3, maximum wet-signal value 306 corresponds to a wet-signal distribution value of 80%. In other embodiments, function 310 varies linearly with distance from boundary 202 up to wet-signal value 306. For example, in one such embodiment, function 310 starts at 0% when virtual sound source 130 is disposed at or within boundary 202 and increases to maximum wet-signal value 306 when virtual sound source 130 is disposed at or beyond a maximum reverb distance 308 (where maximum reverb distance 308 corresponds to virtual sound source 130 being disposed at maximum reverb boundary 208 in FIG. 2). In yet other embodiments, function 310 can include linear and non-linear portions.

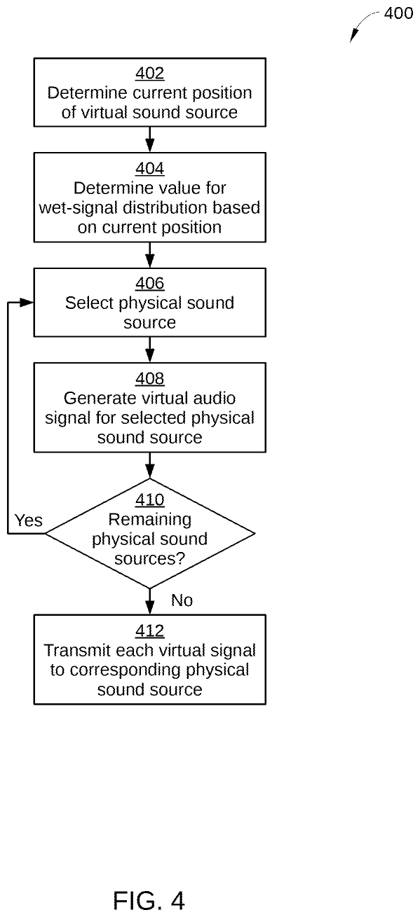

FIG. 4 sets forth a flow diagram of method steps for emulating a distant virtual sound source in an acoustic environment, according to various embodiments of the present disclosure. Although the method steps are described with reference to the systems of FIGS. 1 and 2, persons skilled in the art will understand that any system configured to implement the method steps, in any order, falls within the scope of the present disclosure.

Prior to the method steps, controller 150 determines boundary 202 of listening area 200, for example based on the positions of physical sound sources 110 included in audio system 100. In some embodiments, listening area 200 can be a two-dimensional region in acoustic environment 102. In other embodiments, listening area 200 can be a three-dimensional region in acoustic environment 102.

As shown, a computer-implemented method 400 begins at step 402, where controller 150 determines the current position of virtual sound source 130, for example based on position information 170 received from position sensors 140. In some embodiments, position sensors 140 measure or otherwise determine position information 170, and in other embodiments, position sensors 140 receive position information 170 from virtual sound source 130.

In step 404, controller 150 determines a value for wet-signal distribution 186 based on a distance of virtual sound source 130 from boundary 202 of listening area 200, such as distance 206 in FIG. 2. For example, in some embodiments, the value for wet-signal distribution 186 is determined using a function consistent with function 310 in FIG. 3. Generally, as distance 206 increases above 0, the value for wet-signal distribution 186 increases.

In step 406, controller 150 selects a physical sound source 110 from the plurality of physical sound sources 110 included in audio system 100. In step 408, controller 150 generates a virtual audio signal 180 for the selected physical sound source 110. In some embodiments, controller 150 produces a reverberant signal 184 that is based on the base audio signal 182 for the selected physical sound source 110. In such embodiments, reverberation application generates the reverberant signal 184. Controller 150 then generates the virtual audio signal 180 for the selected physical sound source 110 by mixing the base audio signal 182 with the reverberant signal 184 according to the wet-signal distribution 186 determined in step 404. It is noted that in instances in which the value for the wet-signal distribution 186 is 0%, controller 150 may generate no reverberant signal 184 in step 408, because no wet reverberant signal 184 is mixed with the base audio signal 182 to generate the virtual audio signal 180. As described above, when using reverb for emulation of a distant virtual sound source, no reverb is included in the virtual audio signal 180 when virtual sound source 130 is disposed at or within boundary 202.

In step 410, controller 150 determines whether there are any remaining physical audio sources for which a virtual audio signal 180 is needed. If yes, computer-implemented method 400 returns to step 406; if no computer-implemented method 400 proceeds to step 412. In step 412, controller 150 transmits each virtual audio signal 180 to the corresponding physical sound source 110 in audio system 100. Generally, virtual audio signals 180 are transmitted to physical sound sources 110 concurrently.

### Reverb for Emulation of Virtual Sound Source in Large Acoustic Environment

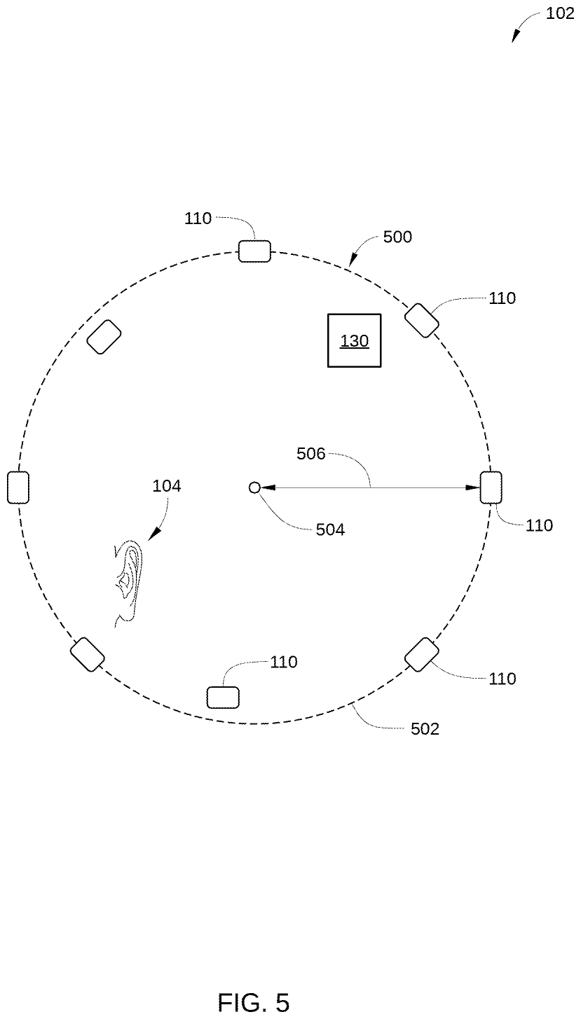

In some embodiments, controller 150 generates virtual audio signals 180 with a reverb signal component (e.g., as reverberant signal 184) to create the perception in a listener that virtual sound source 130 is disposed in a large acoustic environment, such as a very large room. In such embodiments, controller 150 determines a distance-dependent wet-signal distribution 186 based on a size of a listening area in which virtual sound source 130 is disposed. One embodiment of a listening area in acoustic environment 102 is described below in conjunction with FIG. 5.

FIG. 5 is a conceptual illustration of acoustic environment 102 with a listening area 500 disposed therein, according to various embodiments. Also shown in acoustic environment 102 are virtual sound source 130, listener 104, a boundary 502 of listening area 500, a center point 504 of listening area 500, and a characteristic length 506 of boundary 502. As virtual sound source 130 changes position within listening area 500, audio system 100 modifies the virtual audio signals provided to physical sound sources 110 to generate sound localization within listening area 500 that causes listener 104 to perceive sound outputs from physical sound sources 110 to coincide with the current location of virtual sound source 130. According to various embodiments, audio system 100 further modifies these virtual audio signals with a reverb signal component (e.g., reverberant signal 184 in FIG. 1) that is mixed with a base audio signal (e.g., base audio signal 182) based on a distance-dependent wet-signal distribution (e.g., a distance-dependent wet-signal distribution 186). For example, as a size of listening area increases, the value for the distance-dependent wet-signal distribution increases.

As shown, listening area 500 (dashed lines) includes a boundary 502 that indicates an extend of listening area 500. In some embodiments, controller 150 determines boundary 502 based on the positions of physical sound sources 110. For example, in the embodiment illustrated in FIG. 5, boundary 502 is implemented as a circle that encompasses or circumscribes all physical sound sources 110 in acoustic environment 102. In some embodiments, the size and position of the circle is selected to be a circle with the smallest radius that encloses all of physical sources 110. In other embodiments, boundary 202 can be implemented as any other technically feasible shape, such as a polygon, in which each physical sound source 110 corresponds to a vertex, or a geometric shape (e.g., a square, rectangle, triangle, hexagon, and the like) that encompasses all of physical sound sources 110.

According to various embodiments, when a size of listening area 500 is less than a threshold value, a first reverberation approach is employed in the generation of a virtual audio signal 180. Conversely, when a size of listening area 500 is greater than the threshold value, a second reverberation approach is employed in the generation of a virtual audio signal 180. In such embodiments, in the first reverberation approach, virtual audio signals 180 are generated with no reverb signal component, while in the second reverberation approach, virtual audio signals 180 are generated with a reverb signal component that is mixed with a base audio signal based on a distance-dependent wet-signal distribution. Thus, in such embodiments, when listening area 500 is expanded beyond a certain size, a more realistic and natural listening experience is produced for listener 104 by generating virtual audio signals 180 for physical sound sources 110 that cause virtual sound source 130 to be perceived by listener 104 to be in a large acoustic environment.

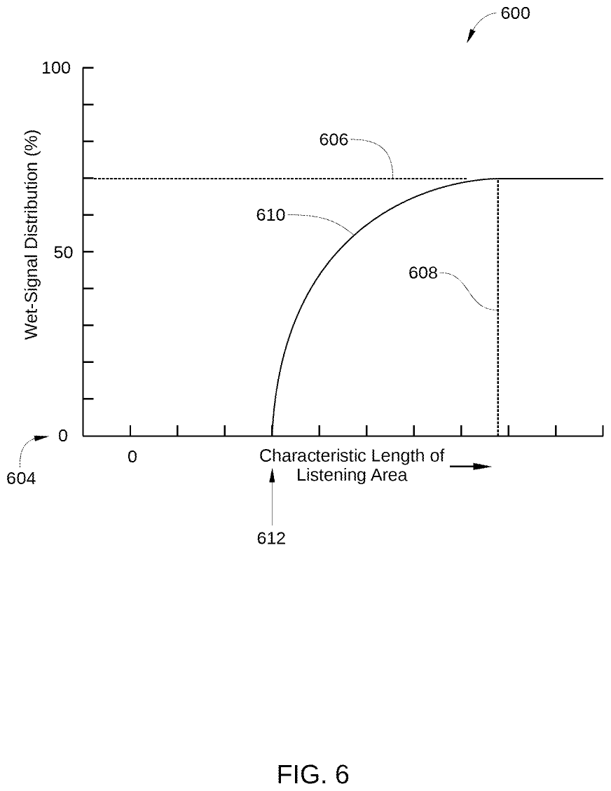

In some embodiments, when a size of listening area 500 exceeds a threshold value, controller 150 (for example via reverberation application 156) generates each virtual audio signal 180 based on a particular base audio signal 182, a reverberant signal 184, and a distance-dependent wet-signal distribution 186. In such embodiments, controller 150 determines a value for distance-dependent wet-signal distribution 186 based on a value indicating the size of listening area 500. For example, in some embodiments, the value indicating the size of listening area 500 is an area of listening area 500. Alternatively, in some embodiments, the value indicating the size of listening area 500 is a characteristic length 506 of listening area 500. In the embodiment illustrated in FIG. 5, boundary 502 of listening area 500 is a circle that encompasses or circumscribes all of physical sound sources 110, and characteristic length 506 is a radius of the circle, extending from a center point 504 to boundary 502. Thus, in such an embodiment, when the radius of listening area 500 exceeds a certain threshold value, controller 150 determines a non-zero value for distance-dependent wet-signal distribution 186 and generates each virtual audio signal 180 based in part on a reverberant signal 184 and on the distance-dependent wet-signal distribution 186. Various embodiments of the determination of wet-signal distribution 186 are described below in conjunction with FIG. 6.

In embodiments in which listening area 500 is not a circle, characteristic length 506 is generally a different feature of boundary 502 than a radius. For example, when listening area 500 is a square or rectangle, characteristic length 506 can be a width of boundary 502, a length of boundary 502, or a diagonal of boundary 502.

FIG. 6 is a graph 600 illustrating a function 610 for determining a value for wet-signal distribution 186, according to an embodiment. Function 610 enables selection of a value of wet-signal distribution 186 based on a characteristic length 506 of listening area 500, such as a radius of boundary 502 in FIG. 5. As shown, function 610 increases from a minimum wet-signal value 604 value of 0% (which corresponds to when characteristic length 506 is less than a threshold value 612) to a maximum wet-signal value 606 (which corresponds to a maximum acceptable reverberation level in sound output, such as when characteristic length 506 equals or exceeds a maximum reverb length 608). In some embodiments, maximum wet-signal value 606 is selected based on a reverberation level that is known to be distracting or unrealistic. Thus, as the size of listening area 500 increases, the value of wet-signal distribution 186 increases, causing virtual audio signals 180 to include a greater mix of reverberant signal 184 and cause a listener to perceive that virtual sound source 130 is located in a larger acoustic environment. It is noted that, as the value of wet-signal distribution 186 (as indicated by function 610) increases, virtual audio signals 180 include a proportionally smaller mix of base audio signal 182. Therefore, function 610 indirectly indicates the mixture of dry signal for virtual audio signals 180.

In the embodiment illustrated in FIG. 6, function 610 varies non-linearly with characteristic length 506 up to maximum wet-signal value 606. For example, in the embodiment illustrated in FIG. 6, maximum wet-signal value 606 corresponds to a wet-signal distribution value of 70%. In other embodiments, function 610 varies linearly with distance from boundary 502 up to wet-signal value 606. For example, in one such embodiment, function 610 starts at 0% when listening area 500 is less than a threshold size and increases linearly to maximum wet-signal value 606 as listening area 500 increases in size. In yet other embodiments, function 610 can include linear and non-linear portions.

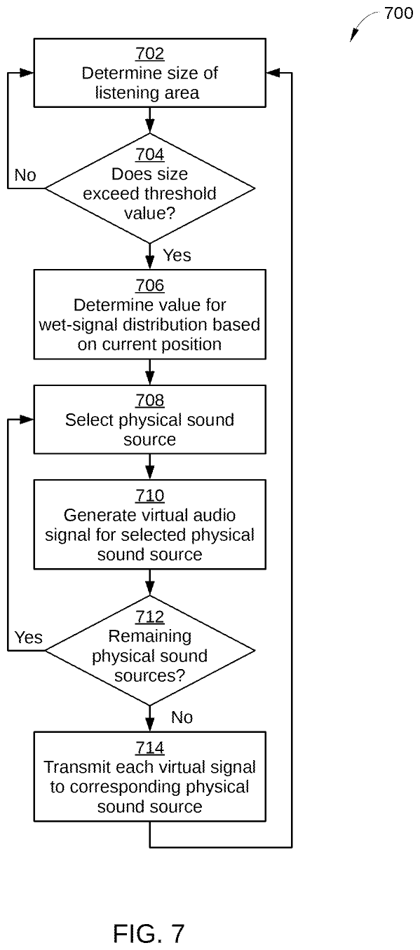

FIG. 7 sets forth a flow diagram of method steps for a distant virtual sound source in a large acoustic environment, according to various embodiments of the present disclosure. Although the method steps are described with reference to the systems of FIGS. 1 and 5, persons skilled in the art will understand that any system configured to implement the method steps, in any order, falls within the scope of the present disclosure.

As shown, a computer-implemented method 700 begins at step 702, where controller 150 determines controller 150 determines a current size of listening area 500, for example based on boundary 502. In some embodiments, controller 150 first determines boundary 502 based on the current positions of physical sound sources 110 included in audio system 100. For example, in some embodiments, controller 150 receives the current positions of physical sources 110 via position information 170 received from position sensors 140. In some embodiments, listening area 500 can be a two-dimensional region in acoustic environment 102. In other embodiments, listening area 500 can be a three-dimensional region in acoustic environment 102. In some embodiments, controller 150 quantifies the current size of listening area 500 based on a characteristic length 506 of boundary 502.

In step 704, controller 150 determines whether the size of listening area exceeds a threshold value. If no, computer-implemented method 700 returns to step 702; if yes computer-implemented method 700 proceeds to step 706.

In step 706, controller 150 determines a value for wet-signal distribution 186 based on a size of listening area 500, such as characteristic length 506 in FIG. 5. For example, in some embodiments, the value for wet-signal distribution 186 is determined using a function consistent with function 610 in FIG. 6. Generally, as characteristic length 506 increases above 0, the value for wet-signal distribution 186 increases.

In step 708, controller 150 selects a physical sound source 110 from the plurality of physical sound sources 110 included in audio system 100. In step 710, controller 150 generates a virtual audio signal 180 for the selected physical sound source 110. In some embodiments, controller 150 produces a reverberant signal 184 that is based on the base audio signal 182 for the selected physical sound source 110. In such embodiments, reverberation application generates the reverberant signal 184. Controller 150 then generates the virtual audio signal 180 for the selected physical sound source 110 by mixing the base audio signal 182 with the reverberant signal 184 according to the wet-signal distribution 186 determined in step 706.

In step 712, controller 150 determines whether there are any remaining physical audio sources for which a virtual audio signal 180 is needed. If yes, computer-implemented method 700 returns to step 708; if no computer-implemented method 700 proceeds to step 714. In step 712, controller 150 transmits each virtual audio signal 180 to the corresponding physical sound source 110 in audio system 100 . . . . Generally, virtual audio signals 180 are transmitted to physical sound sources 110 concurrently. Computer-implemented method 700 returns to step 702.

In sum, an audio system determines a value of a wet-signal distribution based on a distance of a virtual sound source from a boundary of a listening area, or alternately, on a size of the listening area. Virtual audio signals are then generated based on the value of the wet-signal distribution and transmitted to physical sound sources of the audio system to be output. The outputted audio signals generate a reverberant sound environment.

At least one technical advantage of the disclosed techniques relative to the prior art is that the disclosed techniques enhance the perception of distance associated with a virtual sound source and surrounding acoustic environment. A further advantage of the disclosed techniques is that more accurate spatial information is conveyed to the listener, thereby facilitating perception of the location of a virtual sound source. In some instances, a virtual sound source is perceived by a listener to be more distant than is actually the case, and in other instances, the virtual sound source is perceived by the listener to be in a larger acoustic environment than is actually the case. Taken together, the above advantages provide the listener with a more immersive experience in an acoustic environment. These technical advantages provide one or more technological advancements over prior art approaches.

1. In some embodiments, a computer-implemented method for producing a perceived location of a sound source in an acoustic environment includes: determining a current position of a first virtual audio source relative to a listening area of the acoustic environment; based on the current position of the first virtual audio source, determining a wet-signal distribution; generating a first virtual audio signal for a first physical sound source that is included in the acoustic environment, wherein the first virtual audio signal is associated with the first virtual audio source and is based on the wet-signal distribution; and transmitting the first virtual audio signal to the first physical sound source for output by the first physical sound source.

2. The computer-implemented method of clause 1, further comprising: generating a second virtual audio signal for a second physical sound source that is included in the acoustic environment, wherein the second virtual audio signal is associated with the first virtual audio source and is based on the wet-signal distribution; and transmitting the second virtual audio signal to the second physical sound source for output by the second physical sound source.

3. The computer-implemented method of clauses 1 or 2, wherein at least a portion of the first virtual audio signal is transmitted to the first physical sound source while at least a portion of the second virtual audio signal is transmitted to the second physical sound source.

4. The computer-implemented method of any of clauses 1-3, wherein generating the second virtual audio signal based on the wet-signal distribution comprises: generating a reverberant signal based on an audio signal for the second physical sound source; and based on the wet-signal distribution, combining the reverberant signal with the audio signal.

5. The computer-implemented method of any of clauses 1-4, wherein generating the first virtual audio signal based on the wet-signal distribution comprises: generating a reverberant signal based on an audio signal for the first physical sound source; and based on the wet-signal distribution, combining the reverberant signal with the audio signal.

6. The computer-implemented method of any of clauses 1-5, further comprising determining a boundary of the listening area based on a first position in the acoustic environment of the first physical sound source and a second position in the acoustic environment of a second physical sound source.

7. The computer-implemented method of any of clauses 1-6, wherein determining the wet-signal distribution comprises setting the wet-signal distribution to zero when the current position of the first virtual audio source is disposed within the boundary.

8. The computer-implemented method of any of clauses 1-7, wherein determining the wet-signal distribution comprises setting the wet-signal distribution to zero when: the current position of the first virtual audio source is disposed within the boundary; and a size of the listening area is less than a threshold value.

9. The computer-implemented method of any of clauses 1-8, wherein determining the wet-signal distribution comprises setting the wet-signal distribution to a value greater than zero when the current position of the first virtual audio source is disposed outside the boundary.

10. The computer-implemented method of any of clauses 1-9, further comprising: determining a distance between the current position of the first virtual audio source and the boundary; and determining the value greater than zero based on the distance.

11. The computer-implemented method of any of clauses 1-10, further comprising: determining the first position of the first physical sound source based on one of a first signal received from the first physical sound source or an optically determined location of the first physical sound source; and determining the second position of the second physical sound source based on one of a second signal received from the second physical sound source or an optically determined location of the second physical sound source.

12. The computer-implemented method of any of clauses 1-11, wherein the boundary of the listening area corresponds to a circular area that circumscribes the first physical sound source and the second physical sound source.

13. The computer-implemented method of any of clauses 1-12, wherein the current position of the first virtual audio source corresponds to a current position of a toy or a tagged device.

14. In some embodiments, a non-transitory computer-readable medium includes a set of instruction which, in response to execution by a processor of a computing system, cause the processor to emulate a large acoustic space in an acoustic environment by performing the steps of: determining a size of a listening area based on a first position in the acoustic environment of a first physical sound source and a second position in the acoustic environment of a second physical sound source; in response to determining that the size of the listening area exceeds a threshold value, determining a wet-signal distribution based on the size; generating a first virtual audio signal for the first physical sound source, wherein the first virtual audio signal is associated with a first virtual audio source and is based on the wet-signal distribution; and transmitting the first virtual audio signal to the first physical sound source for output by the first physical sound source.

15. The non-transitory computer-readable medium of clause 14, further comprising instructions that, when executed by the processor, cause the processor to further perform the steps of: generating a second virtual audio signal for the second physical sound source, wherein the second virtual audio signal is associated with the first virtual audio source and is based on the wet-signal distribution; and transmitting the second virtual audio signal to the second physical sound source for output by the second physical sound source.

16. The non-transitory computer-readable medium of clauses 14 or 15, wherein at least a portion of the second virtual audio signal is transmitted to the second physical sound source concurrently with at least a portion of the first virtual audio signal being transmitted to the first physical sound source.

17. The non-transitory computer-readable medium of any of clauses 14-16, wherein the size comprises a characteristic length of a boundary of the listening area.

18. The non-transitory computer-readable medium of any of clauses 14-17, wherein the characteristic length of the boundary comprises one of a radius of the boundary, a width of the boundary, a length of the boundary, or a diagonal of the boundary.

19. The non-transitory computer-readable medium of any of clauses 14-18, wherein the first virtual audio source corresponds to a toy or a tagged device.

20. In some embodiments an audio system includes: a first physical sound source and a second physical sound source disposed within an acoustic environment; a memory that stores instructions; and a processor that is communicatively coupled to the memory and is configured to, when executing the instructions, perform the steps of: determining a size of a listening area based on a first position in the acoustic environment of the first physical sound source and a second position in the acoustic environment of the second physical sound source; in response to determining that the size of the listening area exceeds a threshold value, determining a wet-signal distribution based on the size; generating a first virtual audio signal for the first physical sound source, wherein the first virtual audio signal is associated with a first virtual audio source and is based on the wet-signal distribution; and transmitting the first virtual audio signal to the first physical sound source for output by the first physical sound source.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for producing a perceived location of a sound source in an acoustic environment, the method comprising:
determining a current position of a first virtual audio source relative to a listening area of the acoustic environment;
based on the current position of the first virtual audio source, determining a wet-signal distribution;
generating a first virtual audio signal for a first physical sound source that is included in the acoustic environment, wherein the first virtual audio signal is associated with the first virtual audio source and is based on the wet-signal distribution; and
transmitting the first virtual audio signal to the first physical sound source for output by the first physical sound source.

2. The computer-implemented method of claim 1, further comprising:
generating a second virtual audio signal for a second physical sound source that is included in the acoustic environment, wherein the second virtual audio signal is associated with the first virtual audio source and is based on the wet-signal distribution; and
transmitting the second virtual audio signal to the second physical sound source for output by the second physical sound source.

3. The computer-implemented method of claim 2, wherein at least a portion of the first virtual audio signal is transmitted to the first physical sound source while at least a portion of the second virtual audio signal is transmitted to the second physical sound source.

4. The computer-implemented method of claim 2, wherein generating the second virtual audio signal based on the wet-signal distribution comprises:
generating a reverberant signal based on an audio signal for the second physical sound source; and
based on the wet-signal distribution, combining the reverberant signal with the audio signal.

5. The computer-implemented method of claim 1, wherein generating the first virtual audio signal based on the wet-signal distribution comprises:
generating a reverberant signal based on an audio signal for the first physical sound source; and
based on the wet-signal distribution, combining the reverberant signal with the audio signal.

6. The computer-implemented method of claim 1, further comprising determining a boundary of the listening area based on a first position in the acoustic environment of the first physical sound source and a second position in the acoustic environment of a second physical sound source.

7. The computer-implemented method of claim 6, wherein determining the wet-signal distribution comprises setting the wet-signal distribution to zero when the current position of the first virtual audio source is disposed within the boundary.

8. The computer-implemented method of claim 7, wherein determining the wet-signal distribution comprises setting the wet-signal distribution to zero when:
the current position of the first virtual audio source is disposed within the boundary; and
a size of the listening area is less than a threshold value.

9. The computer-implemented method of claim 7, wherein determining the wet-signal distribution comprises setting the wet-signal distribution to a value greater than zero when the current position of the first virtual audio source is disposed outside the boundary.

10. The computer-implemented method of claim 9, further comprising:
determining a distance between the current position of the first virtual audio source and the boundary; and
determining the value greater than zero based on the distance.

11. The computer-implemented method of claim 7, further comprising:
determining the first position of the first physical sound source based on one of a first signal received from the first physical sound source or an optically determined location of the first physical sound source; and
determining the second position of the second physical sound source based on one of a second signal received from the second physical sound source or an optically determined location of the second physical sound source.

12. The computer-implemented method of claim 6, wherein the boundary of the listening area corresponds to a circular area that circumscribes the first physical sound source and the second physical sound source.

13. The computer-implemented method of claim 1, wherein the current position of the first virtual audio source corresponds to a current position of a toy or a tagged device.

14. A non-transitory computer-readable medium that includes a set of instruction which, in response to execution by a processor of a computing system, cause the processor to emulate a large acoustic space in an acoustic environment by performing the steps of:
determining a size of a listening area based on a first position in the acoustic environment of a first physical sound source and a second position in the acoustic environment of a second physical sound source;
in response to determining that the size of the listening area exceeds a threshold value, determining a wet-signal distribution based on the size;
generating a first virtual audio signal for the first physical sound source, wherein the first virtual audio signal is associated with a first virtual audio source and is based on the wet-signal distribution; and
transmitting the first virtual audio signal to the first physical sound source for output by the first physical sound source.

15. The non-transitory computer-readable medium of claim 14, further comprising instructions that, when executed by the processor, cause the processor to further perform the steps of:
generating a second virtual audio signal for the second physical sound source, wherein the second virtual audio signal is associated with the first virtual audio source and is based on the wet-signal distribution; and
transmitting the second virtual audio signal to the second physical sound source for output by the second physical sound source.

16. The non-transitory computer-readable medium of claim 15, wherein at least a portion of the second virtual audio signal is transmitted to the second physical sound source concurrently with at least a portion of the first virtual audio signal being transmitted to the first physical sound source.

17. The non-transitory computer-readable medium of claim 16, wherein the size comprises a characteristic length of a boundary of the listening area.

18. The non-transitory computer-readable medium of claim 17, wherein the characteristic length of the boundary comprises one of a radius of the boundary, a width of the boundary, a length of the boundary, or a diagonal of the boundary.

19. The non-transitory computer-readable medium of claim 14, wherein the first virtual audio source corresponds to a toy or a tagged device.

20. An audio system, comprising:
a first physical sound source and a second physical sound source disposed within an acoustic environment;
a memory that stores instructions; and
a processor that is communicatively coupled to the memory and is configured to, when executing the instructions, perform the steps of:
determining a size of a listening area based on a first position in the acoustic environment of the first physical sound source and a second position in the acoustic environment of the second physical sound source;
in response to determining that the size of the listening area exceeds a threshold value, determining a wet-signal distribution based on the size;
generating a first virtual audio signal for the first physical sound source, wherein the first virtual audio signal is associated with a first virtual audio source and is based on the wet-signal distribution; and
transmitting the first virtual audio signal to the first physical sound source for output by the first physical sound source.
